(19) United States
(12) Patent Application Publication
(10) Pub. No.: US 2004/0173244 A1
(43) Pub. Date: Sep. 9, 2004

(54) Cleaning method for removing starch

(76) Inventors: Werner Strothoff, Fuchtorf (DE); Helmut Maier, Dusseldorf (DE)

Correspondence Address: Andrew D Sorensen, Ecolab Inc, Research and Development Center, 840 Sibley Memorial Highway, Mendota Heights, MN, 55118, US

(21) Appl. No.: 10/479,669

(22) PCT Filed: May 31, 2002
(86) PCT No.: PCT/EP02/05964

(30) Foreign Application Priority Data
Jun. 8, 2001 (DE) 101 27 919.1

(51) Int. Cl. B08B 3/02

(52) U.S. Cl. 134/25.2; 134/29; 134/26; 134/34

(57) ABSTRACT

The described cleaning process comprises an alkaline and an acid cleaning step as well as one or more additional alkaline and/or acid cleaning steps, in particular for the mechanical cleaning of crockery in commercial dishwashers, in which primarily deposits of starch can be removed exceptionally well.

This invention is directed towards a cleaning process comprising an alkaline and an acid cleaning step as well as one or more additional alkaline and/or acid cleaning steps, in particular for the mechanical cleaning of crockery in commercial dishwashers, in which primarily deposits of starch can be removed exceptionally well.

Commercial cleaning machines, depending on type and the field of application, generally contain several tanks arranged one behind the other, out of which rinsing or washing liquid is sprayed onto the wash load passing through the machine. The tanks are usually assembled in the form of a cascade, with the rinsing or washing liquid passing through the tanks in succession from the wash-load outlet to the wash-load inlet. Fresh water is usually supplied to the machines at the outlet. The required quantity of cleaning agent is metered into at least one washing tank, also referred to as a metering tank. Generally, the cleaning agent is metered automatically, depending on the conductivity or the pH value of the washing liquid, or optionally even by means of a time- or cycle-controlled metering pump. It is also possible for several components to be metered separately. For example, a foundation lye solution based on an aqueous alkali hydroxide solution can be introduced initially. One or more additives can then be added to this foundation solution, as required. The dosage of these additives is generally in proportion to the addition of the foundation lye, or is time-controlled. If desired, the metering of the additives may also be governed by the cycle of the chain which transports the wash loads through the machine. Another possible method is a metered addition of additives, or the increase of the additive concentration on the basis of the identification of the additive content of the foundation lye by means of sensory detection of a tracer contained in the additive.

In the case of the cleaning agents employed in practice, deposits of starch, which adhere to the wash load, are frequently not prevented during the conventional mechanical cleaning in a cleaning machine using a conventional concentration of cleanser, and existing deposits of starch are not removed.

The task of dish washing therefore includes the subjection of the crockery exhibiting starch deposits to a so-called thorough cleaning at specific intervals of time. In a thorough cleaning of this kind, the concentration of cleaning agent in the rinsing or washing liquid is significantly increased in comparison with that in standard washing procedures. Another alternative is to spray a highly concentrated alkaline cleaning agent onto the crockery during a conventional dishwashing cycle. A thorough cleaning can also be carried out manually.

For the cleaning of crockery in domestic dishwashers, DE-OS 17 28 093 describes the addition of a clear rinsing agent together with amylase to the rinsing water in order to remove deposits of starch on the crockery. If desired, protease or lipase may also be added to the clear rinsing agent, in addition to the amylase.

Likewise, DE-AS 12 85 087 describes a process for mechanical dishwashing, in which an alkaline cleaning agent is metered into the dishwasher during the main washing operation and an enzyme-containing, in particular amylase-containing, rinsing agent is metered into the dishwasher during the rinsing operation and optionally the prewashing operation. This is done in order to degrade starch formed on the crockery during the rinsing cycle and optionally the prewashing cycle.

WO 94/27488 discloses a process in which a low-alkaline cleaning agent, in particular based on phosphate or nitriloacetic acid (NTA) or its salts, is metered in as cleaning agent and a cleaning promoter containing an enzyme, preferably a carbohydrate-degrading enzyme, in particular amylase, is metered in as additional active ingredient.

In the course of this, it was found that a low-alkaline cleaning agent used in a conventional concentration in combination with an enzyme-containing cleaning promoter results in an excellent removal and inhibition of starch deposits on crockery, even within the short contact times of 10 to 180 seconds which are conventional in commercial dishwashers.

In contrast, the object of the present invention was to provide a solution which, during cleaning in commercial cleaning machines or in domestic machines, lastingly prevents the formation of a starch coating on the wash load and/or degrades or removes existing starch coatings and does not necessarily require the use of enzymes, bleaching agents, or extremely high alkalinity.

Accordingly, the present invention provides a cleaning process comprising an alkaline and an acid cleaning step as well as one or more additional alkaline and/or acid cleaning steps, in particular for the mechanical cleaning of crockery in commercial dishwashers.

WO 98/30673 has already publicised a process for cleaning crockery, in which a first and a second cleaning agent are used and one of these cleaning agents has an acid pH value and the other has an alkaline pH value, and the crockery is rinsed with water on each occasion before, between and after the application of the above-mentioned cleaning agents. The above-mentioned process is preferably to be used in order to achieve a rapid disinfection of the crockery. The present invention clearly differs from this known process. Whereas WO 98/30673 mentions one alkaline and one acid cleaning step, the present invention is based on a process in which two cleaning steps are carried out within a uniform pH range, which is within the acid or alkaline pH range, and at least a third step is carried out at a contrasting pH value. This principle, in no way described or recognised in WO 98/30673, leads to unexpected results during cleaning, in particular in the removal of starch deposits. The observed effect, which is illustrated in the Examples of this Application, surpasses the effect which a person skilled in the art would have anticipated from the addition of an additional cleaning step.

Apart from that, in WO 98/30673 the change in pH value was in no way associated with the improvement in the removal of starch deposits. Consequently, the object which the present invention sets itself proceeds in quite a different direction and also arrives at a different result. Whereas a process which is based on two cleaning steps with contrasting pH values leads to mediocre results as regards the removal of starch deposits, the process according to the invention yields distinctly better results. In this connection, it is preferred that in the process according to the invention, at least one alkaline cleaning step be followed by an acid cleaning step and that this acid cleaning step be followed by an alkaline cleaning step, with the proviso that there are in total at least three and particularly preferably not more than eight cleaning steps. In the process according to the invention, it is particularly preferred that the first of the above-mentioned cleaning steps be an alkaline cleaning step.

For the process according to the invention, it is particularly preferred that in the alkaline step and/or in the acid step, cleaning is carried out using dilute solutions, and not the concentrates.

Thus, in the process according to the invention it is preferred that, in the alkaline cleaning step or steps, the surface to be cleaned be brought into contact with one or more aqueous cleaning solutions containing between 0.1 and 4 wt. % of an alkaline carrier, preferably a hydroxide selected from sodium hydroxide, potassium hydroxide or mixtures of these, and that the pH value be particularly preferably above 9 and most preferably above 10. However, it is not necessary for the alkalinity to be greater than 13.

Examples of other preferred alkaline carriers—in addition to or instead of hydroxides selected from sodium hydroxide and potassium hydroxide—which may be mentioned are alkali silicates, ethanolamines, such as triethanolamine, diethanolamine and monoethanolamine, as well as alkali carbonate alkaline carriers, preferably a hydroxide selected from sodium hydroxide and potassium hydroxide. Other alkaline carriers may, of course, also be used, as it is primarily the increase in the pH value which is important.

Likewise, in the process according to the invention it is preferred that, in the acid cleaning step or steps, the surface to be cleaned be brought into contact with one or more aqueous cleaning solutions containing between 0.1 and 10 wt. %, particularly preferably between 0.1 and 5 wt. %, of one or more acids, and that the pH value be preferably below 5 and most preferably below 2 and/or the acids are selected particularly preferably from among the mineral and/or organic acids and most preferably are sulfuric acid, nitric acid, hydrochloric acid, phosphoric acid, formic acid, acetic acid, glycolic acid, citric acid, maleic acid, lactic acid, gluconic acid, alkylsulfonic acid, amidosulfonic acid, succinic acid, glutaric acid, adipic acid, phosphonic acids, polyacrylic acids or mixtures of these.

Here, it is particularly preferred that the above-mentioned acid be a component having complexing properties.

Preferably, in the acid cleaning step or steps of the process according to the invention, the surface to be cleaned is brought into contact with one or more aqueous cleaning solutions containing at least one corrosion inhibitor and/or a conventional complexing agent, particularly preferably selected from among the phosphonic acids, in particular dioctyl phosphonic acid.

In another preferred embodiment of the process according to the invention, the temperature of the above-mentioned cleaning solutions is between 35° C. and 80° C. It is also preferred that, after the final cleaning step, the surface being cleaned be treated with a preferably acid or neutral aqueous solution containing at least one clear-rinsing component.

The time required for each of the above-mentioned cleaning steps in the process according to the invention is preferably between 10 seconds and 30 minutes. Here, it is necessary to consider whether the process according to the invention is being applied in a domestic or a commercial machine. Because of the preset standards in practice, the time required per cleaning step in commercial machines is preferably 10 seconds to 10 minutes. In domestic machines, however, periods of 1 to 30 minutes per cleaning step are usual.

As already repeatedly explained, the process according to the invention is used most preferably for detaching starch from surfaces. It has been found, moreover, that mineral contaminants can be removed particularly efficiently by means of the process according to the invention. The process according to the invention can be used with advantage particularly for residues, such as residues of coffee or tea, which contain mineral contaminants. In addition, the process according to the invention is used preferably for cleaning crockery in the domestic field and particularly preferably in the commercial field.

It may be further explained that, where there are at least two alkaline steps in the process according to the invention, it is particularly preferred that the earlier alkaline step in the procedure have a lower pH value than that of the later alkaline step in the procedure. This is advantageous, in order to maintain the weakening occurring during an intermediate acid step as low as possible.

The process according to the invention can be carried out using multi-tank or single-tank machines.

In the case of machines having one tank, the acid component is preferably introduced via the clear-rinsing arm. Here the main cleaning bath is preferably alkaline. Such an embodiment of the process according to the invention is also preferred where domestic machines are used.

The present invention also provides a commercial dishwasher containing several tanks, which are assembled in known manner in the form of a cascade and out of which rinsing or washing liquid is sprayed against the crockery, in order then to run off again into the tanks. Here the tanks, which by virtue of a process according to the invention are intended for one or more acid cleaning steps, consist of acid-resistant material and/or are lined with acid-resistant material.

The present invention also provides a single-tank washing machine, for example, a domestic dishwasher, which is suitable for a process according to the invention and, at those positions which, by virtue of the process according to the invention come into contact with acid cleaning solutions, consists of acid-resistant material and/or is lined with acid-resistant material, in particular when it is not foreseeable that these positions will subsequently come into contact with alkaline agents.

### EXAMPLES

For each test, at room temperature 10 new, dry plates were soiled with a starch-containing contaminant, using a standardised test method. For this, a composition containing an approximately 6% aqueous maize starch was heated to 75° C. and then cooled and approx. 4 ml of this was applied to each plate by means of a brush. The plates thus treated were allowed to stand for at least 3 hours and were then allowed to dry for 16 hours at approx. 100° C. The plates were cooled down and then comparative tests were carried out in a Krefft® single-tank dishwasher, in accordance with the following scheme.

a) Clean for 1 minute using a 0.3 wt. % aqueous solution of a conventional, consistently alkaline cleaning agent (approx. 17 wt. % alkali hydroxide, 14 wt. % tripolyphosphate and 1.5 wt. % alkali hypochlorite as well as approx. 1 wt. % alkali silicate, the remainder being water).

b), Cover the surfaces of the plates by spraying, for each test using a different spraying solution, the composition of which is given in more detail in Table 1.

c) Allow the applied spraying solution to act for 30 seconds.

d) Clean for 2 minutes with a solution as in a).

The cleaning solution and spraying solutions provided had been produced using softened water. The cleaning temperature in the Krefft® single-tank dishwasher was 60° C.

Firstly, 4 tests were carried out in accordance with the described scheme, the compositions of the cleaning solutions a) and d) being retained and only the spraying solutions being changed from test to test.

The results of cleaning were assessed, depending on the success in cleaning, by numbers from 1 (no detectable success in cleaning) to 10 (complete removal of contaminants).

The results of the 4 tests may be seen in Table 1.

TABLE 1
Results of cleaning in tests in accordance with the
described scheme, with only the spraying solutions
being changed from test to test

| | | Assessment of |
|---|---|---|
| | | cleaning |
| Test | Spraying solution | performance |
| 1 | 1% NaOH | 4.6 |
| 2 | 0.3 g/l Perzym | 1.2 |
| 3 | 1% methanesulfonic acid 70% | 9.5 |
| 4 | Water | 1.2 |

From Table 1, it is clear that by far the best cleaning results were achieved in Test 3. In Test 3, a solution of methanesulfonic acid was used as spraying solution. The principle of cleaning for this very favourable case was thus that cleaning steps were first of all alkaline-, then acid and subsequently again alkaline.

Further investigations showed that an acid pH value is essential for the cleaning performance and the type of acid used is of secondary importance. Thus, where equivalent quantities of phosphoric acid were used in exchange for methanesulfonic acid in Test 3, the result of cleaning was equally as good as with methanesulfonic acid.

1. Cleaning process for commercial or domestic cleaning machines, comprising an alkaline and an acid cleaning step as well as one or more additional alkaline and/or acid cleaning steps.

2. Process according to claim 1, characterised in that at least one alkaline cleaning step is followed by an acid cleaning step and that this acid cleaning step is followed by an alkaline cleaning step, with the proviso that there are in total at least three cleaning steps.

3. Process according to either of claims 1 or 2, characterised in that the first of the above-mentioned cleaning steps is an alkaline cleaning step.

4. Process according to one or more of claims 1 to 3, characterised in that in the alkaline cleaning step or steps, the surface to be cleaned is brought into contact with one or more aqueous cleaning solutions containing between 0.1 and 4 wt. % of an alkaline carrier, preferably a hydroxide selected from sodium hydroxide, potassium hydroxide or mixtures of these.

5. Process according to one or more of claims 1 to 4, characterised in that in the acid cleaning step or steps, the surface to be cleaned is brought into contact with one or more aqueous cleaning solutions containing between 0.1 and 10 wt. % of one or more acids.

6. Process according to claim 5, characterised in that the above-mentioned acid is a mineral and/or organic acid, preferably selected from sulfuric acid, nitric acid, phosphoric acid, formic acid, acetic acid, glycolic acid, citric acid, maleic acid, lactic acid, gluconic acid, alkylsulfonic acid, amidosulfonic acid, succinic acid, glutaric acid, adipic acid, phosphonic acids, polyacrylic acids or mixtures of these.

7. Process according to claim 6, characterised in that the above-mentioned acid is a component having complexing properties.

8. Process according to one or more of claims 4 to 7, characterised in that in the temperature of the above-mentioned cleaning solutions is between 35° C. and 80° C.

9. Process according to one or more of claims 1 to 8, characterised in that, after the final cleaning step, the surface being cleaned is treated with a preferably acid or neutral aqueous solution containing at least one clear-rinsing component.

10. Process according to one or more of claims 1 to 9, characterised in that the time required for each of the above-mentioned cleaning steps is between 10 seconds and 30 minutes.

11. Process according to one or more of claims 1 to 10 for removing mineral contaminants and/or for detaching starch from surfaces.

12. Process according to one or more of claims 1 to 11 for cleaning crockery in the domestic field and in the commercial field.

13. Commercial dishwasher containing several tanks, which are assembled in known manner in the form of a cascade and out of which rinsing or washing liquid is sprayed against the crockery, in order then to run off again into the tanks, characterised in that the tanks, which according to one or more of claims 1 to 12 are intended for one or more acid cleaning steps, consist of acid-resistant material and/or are lined with acid-resistant material.

14. Single-tank washing machine, for example, a domestic dishwasher, which is suitable for a process according to one or more of claims 1 to 12 and, at those positions which by virtue of a process according to claims 1 to 12 come into contact with acid cleaning solutions, consists of acid-resistant material and/or is lined with acid-resistant material.
